(19) United States
(12) Patent Application Publication
(10) Pub. No.: US 2023/0417199 A1
(43) Pub. Date: Dec. 28, 2023

(54) ENGINE CONTROL DEVICE FOR AN INTERNAL COMBUSTION ENGINE, FEATURING COLLECTIVE ADJUSTMENT OF ENGINE OPERATING PARAMETERS

(71) Applicant: FRAUNHOFER-GESELLSCHAFT ZÜR FORDERUNG DER ANGEWANDTEN FORSCHUNG E.V., München (DE)

(72) Inventors: Julius Pfrommer, Karlsruhe (DE); Janina Stompe, Karlsruhe (DE); Johannes Sailer, Karlsruhe (DE); Jürgen Beyerer, Karlsruhe (DE); Christian Frey, Karlsruhe (DE)

(21) Appl. No.: 18/252,866

(22) PCT Filed: Nov. 10, 2021
(86) PCT No.: PCT/EP2021/081187

§ 371 Date: May 12, 2023

(30) Foreign Application Priority Data
Nov. 12, 2020 (DE) 10 2020 214 254.8

(51) Int. Cl. F02D 29/02; F02D 41/14; F02D 41/24; F02D 41/26; H04W 4/46; G06N 3/08; G08G 1/00

(52) U.S. Cl. CPC F02D 29/02; F02D 41/1406; F02D 41/2422; F02D 41/2487; F02D 41/266; H04W 4/46; G06N 3/08; G08G 1/20; B60K 2370/5915; B60W 2556/65; F02D 2200/703

(57) ABSTRACT

The invention relates to an engine control unit (1, 1′) for an internal combustion engine of a fleet vehicle (2, 2′) in a vehicle fleet with at least two fleet vehicles (2, 2′) with a control unit (3, 3), which is configured for setting control variables based on measured variables according to a control scheme stored in the engine control unit (1, 1′); and with a data interface unit (4, 4′), which is configured to transmit respective engine operating data sets to/from another engine control unit (1, 1′) of a respective drive internal combustion engine of at least one other fleet vehicle (2, 2′); wherein the control unit (3, 3′) is configured to set the control variables while considering at least one engine operating data set of the other engine control unit(s) (1, 1′) received via the data interface unit (4, 4′), in order to provide an improved control for the internal combustion engine.

### CROSS-REFERENCE TO RELATED APPLICATION

This application claims priority to PCT Patent Application No. PCT/EP2021/081187, filed Nov. 10, 2021, which claims priority to German Patent Application No. 10 2020 214 254.8, filed Nov. 12, 2020, both of which are incorporated by reference in their entireties.

### FIELD OF THE INVENTION

The invention relates to an engine control unit for an internal combustion engine, in particular a drive internal combustion engine, of a fleet vehicle in a vehicle fleet with at least two, thus two or more fleet vehicles, which has a control unit for setting control variables on the basis of measured variables according to a control scheme stored in the engine control unit.

### BACKGROUND

Modern engine control units in internal combustion engines of vehicles control or regulate the internal combustion engine based on a control scheme. This control scheme, which may be present, for example, in the form of a high-dimensional map for the engine operating parameters (or, in general, comprising such an operating parameter map), corresponds to a mathematical mapping of a number of measured variables, which may also be designated as input engine operating parameters, onto a number of control variables, which may be designated as output engine operating parameters.

The control variables are thereby output from the corresponding control unit of the engine control unit, typically as voltage, wherein both the level of the corresponding voltage and also the time of the application, the “timing” of the corresponding voltage, determine the corresponding control variables. Thus, for example, the amount of the corresponding voltage for a throttle valve position may encode a respective throttle valve angle as an output engine operating parameter. In contrast, the ignition timing is generally set as an output engine operating parameter via the timing of the corresponding voltage, i.e., the precise timing of a corresponding voltage peak in the associated control channel, wherein the timing may be predetermined as a relative timing with respect to an operating cycle of the internal combustion engine, for example, with respect to a top dead center. The input engine operating parameters may be present both as (analog) voltages and also as an encoded digital signal, for example, as a data signal from corresponding sensors, or as data signal which contains values from a corresponding processor unit, calculated on the basis of corresponding sensor values. The control scheme, for example, in the form of a multi-dimensional operating parameter map, then maps a higher-dimensional measured variable space of, for example nine dimensions, onto a lower-dimensional control variable space of, for example three dimensions.

The ideal control scheme for an internal combustion engine generally also depends here on factors which are not explicitly considered in the control scheme. For example, fuel quality, air pressure, humidity, ambient temperature, or other environmental parameters, which may vary during operation of the internal combustion engine and are often unpredictable when configuring the engine control unit, also change a behavior of the internal combustion engine. In practice, a universal control scheme is correspondingly stored in the engine control units, which provides stable acceptable results with respect to, for example, torque response, fuel consumption or exhaust gas composition of the internal combustion engine, for different environmental parameters, i.e., different varying values of one or more environmental parameters. A torque response here describes the curve of an actual torque of the internal combustion engine provided in response to a requested target torque.

The first prerequisite for achieving an improved engine control for internal combustion engines in real conditions is described in US 2004/133 336 A1, in which a vehicle's combustion performance is remotely identified, in order to enable remote monitoring of vehicle performance.

It is correspondingly an object of the present invention to provide an improved control for an internal combustion engine, which enables real environmental conditions of the internal combustion engine to be better considered during control of the same.

### SUMMARY

This problem is solved by the subject matter of the independent patent claims. Advantageous embodiments result from the dependent patent claims, the description, and the FIGURE.

One aspect relates to an engine control unit for an internal combustion engine, in particular a drive internal combustion engine, for example, a gasoline, diesel, or hydrogen internal combustion engine, of a fleet vehicle. A fleet vehicle is a vehicle of a vehicle fleet with at least two, preferably more than two, in particular a plurality of vehicles.

The engine control unit has a control unit, which is configured to set control variables on the basis of measured variables according to a control scheme stored in the engine control unit, in particular in the control unit. The control scheme is, in the mathematical sense, a mapping of the measured variables onto the control variables, which describes a control response of the control unit. The control scheme may correspondingly comprise or be, for example, a map, a so-called operating parameter map. This type of map is generally high dimensional, it may thus, for example, have three or more, six or more, nine or more, twelve of more dimensions. Setting, in the scope of the present disclosure, may also be understood as a setting in the meaning of controlling or regulation.

The engine control unit also has a data interface unit, which is configured to transmit, i.e., to send and/or receive, respective engine operating data sets to or from another engine control unit of a respective internal combustion engine of at least one other fleet vehicle. The data interface unit may thus transmit, that is, send, be it directly or indirectly, engine operating data sets of its own engine control unit to one or more engine control units of respective other fleet vehicles. Alternatively or supplementally, its own engine control unit may also receive, be it directly or indirectly, respective engine operating data sets from one or more other respective fleet vehicles. The control unit is thereby configured to set the control variables while considering, in particular on the basis of, at least one engine operating data set of the other engine control unit received via the data interface unit. The control unit may subsequently compare the received engine operating data sets with its corresponding own operating data, i.e., its own measured variables, its own control variables, and its own control scheme stored in the engine control unit, and also other operating data, and then, for example, either reject the received engine operating data set of the other engine control unit and rely on its own control scheme, or set the control variables on the basis of the received engine operating data set of the other engine control unit, if necessary with recourse to its own control scheme. Provision may be made to ignore the received engine operating data set(s) if a predetermined criterion is not satisfied. The predetermined criterion may, for example, represent a predetermined reliability, whether, for example, sufficient historical experience or a predetermined number of sufficiently similar engine operating data sets is available according to the criterion, for the current operating point of its own internal combustion engine.

For example, an engine control unit of a fleet vehicle, which is generally used at low altitudes above sea level and thus at comparatively high air pressure, may, during a trip into the mountains, during which the air pressure also decreases at an increased operating altitude above sea level and the internal combustion engine thus has an operating behavior that differs from normal operation at low elevations, access an engine operating data set from another engine control unit which is used and thus tested in this environment, i.e., presently at a reduced air pressure. The control scheme may thus be optimized, for example, with respect to a predetermined optimization parameter, like a torque response, fuel consumption, or exhaust gas composition. This has the advantage of a generally improved behavior of the internal combustion engine, which may thus be operated both in a more environmentally friendly way and also more user friendly and durable way, as a behavior desired by the user, like a torque, may be achieved more reliably and/or faster and/or with lower environmental impact and/or with less fuel consumption.

In one advantageous embodiment, the engine operating data sets, as respective operating data, comprise at least one measured variable and/or at least one control variable and/or at least one control scheme and/or at least one environmental parameter characterizing an environment of the engine control unit and/or an optimization parameter, which evaluates a control scheme, in particular a partial aspect of a control scheme, for example, a section of an operating parameter map. The respective operating data may thereby be, in each case, time-dependent operating data, thus stored in a chronological sequence and/or correlated.

The measured variables described here and above may comprise, in particular, an engine rpm and/or a throttle valve position and/or a fuel injection amount and/or a residual combustion gas amount and/or an ignition timing and/or a valve opening time and valve closing time and/or an engine temperature and/or an intake-side gas mixture pressure (in particular from the previous operating cycle) and/or a pressure in the combustion chamber (in particular from the previous operating cycle) and/or an exhaust-side gas mixture pressure (in particular from the previous operating cycle) and/or an engine torque and/or an engine mileage. The control variables listed here and above may comprise, in particular, a throttle valve position and/or a fuel injection amount and/or an ignition timing and/or valve opening time and valve closing time (a phase adjuster for the valves) and/or a turbocharger charging pressure. The control scheme described here and above may be or may comprise, in particular, an operating parameter map. A corresponding partial section of the control scheme may thereby be a section of the operating parameter map. The environmental parameters described here and above may comprise, in particular, a geographic position of the vehicle, preferably with a geographic altitude indication, and/or an engine ambient air pressure and/or an engine ambient humidity and/or an engine ambient temperature and/or a fuel quality and/or an internal combustion engine type designation and/or a fleet vehicle type designation and/or a fleet vehicle mass, i.e., a mass of the fleet vehicle associated with the respective engine control unit from which the engine operating data sets originate. The listed operating data have thereby each proven to be particularly advantageous.

In one advantageous embodiment, the data interface unit comprises or is a wireless fleet-vehicle-to-fleet-vehicle data interface unit. Such a fleet-vehicle-to-fleet-vehicle data interface unit may also be designated as a car-to-car data interface unit. In particular, the data interface unit may have a limited transmission range due to technical reasons, which (in particular under real usage conditions) may be less than 10 km or less than 5 km or less than 2 km or less than 1 km. For example, the data interface unit may be or comprise a wireless local area network (WLAN) data interface unit or may be or comprise a near-field wireless data interface unit (for example, Bluetooth, BT).

Engine operating data sets may thus only be exchanged in an environment, predetermined by the limited range, of the fleet vehicle associated with the engine control unit. This has the advantage that information about the environment of the engine control unit, which influences the behavior of the internal combustion engine is implicitly transmitted, i.e., environmental parameters, which are not explicitly detected and do not change, or scarcely change in a sufficiently small environment of the fleet vehicle, are also considered. In a respective environment of the engine control unit, and thus of the fleet vehicle, many parameters, for example, air pressure, humidity, or ambient temperature, are at least generally similar. Due to the fact that its own engine control unit in the environment does not have to first run through different setting possibilities, which are not adapted to the present environment or not proven in this environment, but instead may directly adopt an already used and thus proven control scheme and/or used and thus proven other operating data from another fleet vehicle, its own engine control unit may achieve an optimized control particularly fast, i.e., ensure ideal operating conditions of the internal combustion engine controlled by its own engine control unit.

In another advantageous embodiment, the data interface unit comprises or is a wireless fleet-vehicle-to-fleet-server data interface unit. Such a fleet-vehicle-to-fleet-server data interface unit may also be designated as a car-to-car-server or car-to-infrastructure data interface unit. In connection with the above car-to-car data interface unit, a car-to-X data interface unit thus arises, which may communicate with any infrastructure components and/or other fleet vehicles. In this case, the data interface unit is thus correspondingly configured to transmit the engine operating data sets to one or more respective other engine control units via a fleet server. For example, this may be a cellular (in particular LTE or 5G) data interface unit. This initially has the advantage that engine operating data sets may also be made available, which have provided suitable results farther in the past, i.e., have provided useful results in an advantageous way for controlling their own internal combustion engine. Thus, for example, in the above mentioned example, an engine operating data set, which was used and tested in the same environment, however at a different time, for example, on the previous day, may also be used by its own engine control unit. This is advantageous to the extent that many environmental parameters, for example, air pressure, are often similar at the same location, even on different days. Furthermore, the number of the available engine operating data sets may thus also be increased, so that in particular many different engine operating data sets may be provided via the fleet server, and thus the probability is increased that a particularly suitable engine operating data set will be found. This will also be subsequently described in greater detail in conjunction with the memory unit.

In another advantageous embodiment, the engine control unit has a memory unit which is configured to store different engine operating data sets of one or more other engine control units provided at different points in time and/or from engine control units of different other fleet vehicles. The provided engine operating data sets may thereby be transmitted directly, i.e., from another engine control unit, or indirectly, i.e., from the described fleet server, from an engine control unit to an engine control unit. Alternatively or supplementally, the memory unit may also be configured in the fleet server. The engine control unit or correspondingly the fleet server thereby also has a selection unit, which is configured to select at least one engine operating data set from the engine operating data sets stored in the memory unit, on the basis of which the control unit sets the control variables, or to decide that the control variables, based on its own measured variables, are set according to the control scheme stored in the engine control unit. This has the advantage that suitable operating parameters may be used in each case, selected, for example, on the basis of an optimality criterion, from a large number of available engine operating data, and thus the control of the internal combustion engine is improved.

In another advantageous embodiment, the stored engine operating data sets comprise in this case at least one environmental parameter and other engine operating data, in particular a control scheme, and the selection unit is configured to compare the at least one environmental parameter of the stored operating data sets with a corresponding environmental parameter, detected locally by the engine control unit, that is at or in the assigned vehicle, and, on the basis of a comparison result, to select the engine operating data set and thus the respective engine operating data from the stored engine operating data sets, on the basis of which the control unit sets the control variables.

Alternatively or supplementally, the stored engine operating data sets each comprise at least one optimization parameter, as these will be introduced farther below, and other engine operating data, in particular a control scheme, and the selection unit is configured to compare the at least one optimization parameter of the stored operating data sets with a corresponding optimization parameter derivable locally by the engine control unit for its own control scheme already stored in the control unit, and, on the basis of a comparison result, to select the engine operating data set and thus those engine operating data from the stored engine operating data sets, on the basis of which the control unit sets the output engine operating parameters.

This has the advantage that those engine operating data sets are selected for setting the output engine operating parameters, which are most promising for optimal operation in the corresponding environment or at the given time.

Provision is thereby made that the selection unit is configured to select an engine operating data set for setting the control variables by the control unit, for which the comparison result yields the lowest deviation from the environmental parameter locally detected by the engine control unit and/or the greatest improvement in comparison to the optimization parameter(s) determined by the engine control unit for its own operating data. This has the advantage that, in the given situation, the engine operating parameters of the most similar environment or with the best control characteristics are selected for the engine control unit.

In another advantageous embodiment, a generation unit is present, which is, in particular, part of the selection unit, and which is configured to generate at least one meta engine operating data set from the engine operating data sets stored in the memory unit. The engine operating data sets underlying the meta engine operating data set may thereby originate from multiple different engine control units or the same engine control unit at different times. The engine operating data sets underlying the respective meta engine operating data set preferably comprise at least one environmental parameter and/or one optimization parameter, which differ from one another in their values by less than a predetermined limit value. Thus, engine operating data sets from similar environments and/or of similar optimization quality are combined into a meta engine operating data set. For example, the different engine operating data sets may be converted into the meta engine operating data set by averaging the values of the respective parameters. This has the advantage that a larger stability and thus an increased reliability of the engine control unit in the different conditions is also achieved by using engine operating data sets originating from other engine control units.

Provision may additionally be made here that the generation unit generates the at least one meta engine operating data set from the stored engine operating data sets by means of machine learning. The machine learning thereby optimizes, in particular, a predetermined optimization parameter, already referenced above, which, for example, may be or comprise a torque response of the internal combustion engine and/or a fuel consumption of the internal combustion engine and/or an exhaust gas composition of the internal combustion engine corresponding to an optimization specification. This has the advantage that a particularly flexible and adaptable engine control is achieved for the internal combustion engine. In addition, the method of machine learning is very particularly advantageous here, as a large amount of operating data is present as the basis for the learning. This applies in particular for time-dependent engine operating data, which is typically collected multiple times in each combustion cycle, so that thousands of evaluatable data sets are generated per minute of operation of the internal combustion engine. The use of neural networks, which are trained by means of a stochastic gradient descent, have proven particularly advantageous for machine learning.

The machine learning may thereby be carried out both in real time, thus during the control time, and also previously according to the availability of the data underlying the learning. In particular, the learning may also be configured to be switchable between “learning in real time” and “prior learning”.

The generation unit, described in the last paragraphs, may also be implemented in a fleet server of an engine control unit system. The engine control unit system thereby has at least two engine control units according to one of the described embodiments and a fleet server which is configured to transmit the engine operating data between the at least two engine control units, and comprises a memory unit which is configured for storing transmitted engine operating data sets.

Correspondingly, a further aspect relates to an engine control system with at least two engine control units according to one of the listed embodiments and a fleet server which is configured to transmit the engine operating data between the at least two engine control units.

A further aspect relates to a motor vehicle with an engine control unit according to one of the described embodiments.

Yet a further aspect relates to a method for operating an engine control unit of an internal combustion engine of a fleet vehicle in a vehicle fleet with at least two fleet vehicles, which comprises the method step of transmitting engine operating data sets from one engine control unit to at least one other engine control unit of an internal combustion engine of a respectively other fleet vehicle via a data interface unit. Advantages and advantageous embodiments of this method correspond here to the advantages and advantageous embodiments described for the engine control unit.

A concluding aspect relates to a method for operating an engine control unit of an internal combustion engine of a fleet vehicle in a vehicle fleet with at least two fleet vehicles with the following method steps: Transmitting at least one engine operating data set from at least one other engine control unit of an internal combustion engine of a respectively other fleet vehicle to its own engine control unit via a data interface unit; setting control variables of the engine control unit while considering at least one of the engine operating data sets of the engine control unit of the at least one other engine control unit received via the data interface unit.

Here as well, the advantages and advantageous embodiments of the described engine control unit apply.

The features and combinations of features, previously listed in the description, and in the introductory part, and the features and combinations of features subsequently mentioned in the description of the FIGURE and/or only shown in the FIGURE are applicable, not only in the respectively indicated combination, but also in other combinations, without leaving the scope of the invention. Thus, embodiments of the invention are also to be considered as comprised and disclosed, which are not explicitly shown or explained in the FIGURE; however, arise and are producible by separate combinations of features or from the explained embodiments. Embodiments and combinations of features are also to be considered disclosed that thus do not have all features of one of the originally formulated independent claims. In addition, embodiments and combinations of features are to be considered disclosed, in particular by the embodiments explained above, which exceed or deviate from the combinations of features represented in the references of the claims.

The subject matter according to the invention will be explained in greater detail on the basis of the schematic drawings shown in following FIGURE, without wishing to be limited to the specific embodiments shown here.

### BRIEF DESCRIPTION OF THE DRAWINGS

FIG. 1 is a schematic illustration of engine control units 1, 1′ in respective fleet vehicles 2, 2′ in accordance with aspects of the disclosure.

### DETAILED DESCRIPTION

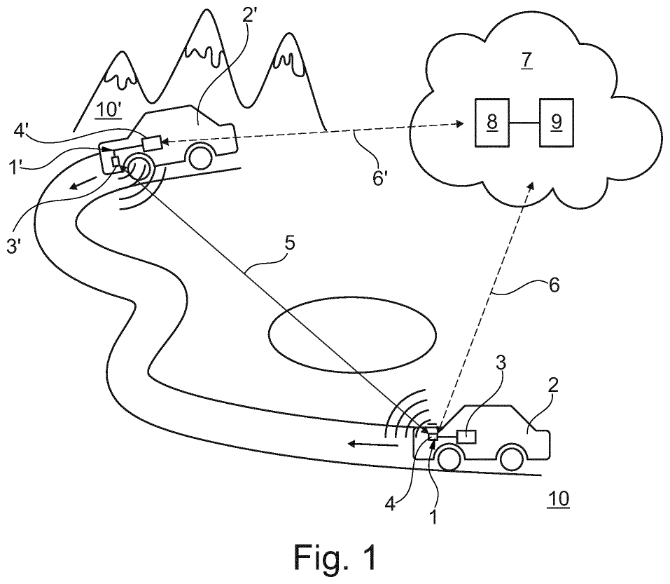

FIG. 1 shows respective engine control units 1, 1′ in respective fleet vehicles 2, 2′, which are respectively equipped with an internal combustion engine (not shown) controlled by corresponding engine control unit 1, 1′. Each of engine control units 1, 1′ has a control unit 3, 3′, which is configured to control the respectively assigned internal combustion engine. This is carried out by setting the respective control variables on the basis of measured variables according to a control scheme stored in engine control unit 1, 1′, for example, in control unit 3, 3′. The control scheme may, for example, be stored in the form of a multi-dimensional map.

Furthermore, engine control units 1, 1′ have a respective data interface unit 4, 4′, which is configured to transmit respective engine operating data sets to or from another engine control unit 1, 1′ of another fleet vehicle 2, 2′. The engine operating data sets may thereby completely or partially comprise the listed respective control variable and/or the listed measured variable and/or the listed control scheme. The engine operating data sets may also additionally comprise corresponding environmental parameters or optimization parameters. Both control units 3, 3′ is thereby configured to set the control variable while considering at least one engine operating data set of the other engine control units 1, 1′ received via data interface unit 4, 4′.

In the example shown, respective data interface unit 4, 4′ are both wireless fleet-vehicle-to-fleet-vehicle data interface units and also wireless fleet-vehicle-to-fleet-server data interface units. Correspondingly, both engine control units 1, 1′ may directly transmit or exchange engine operating data sets between one another via a radio connection 5, for example, a wireless local area network (WLAN), and also indirectly transmit the corresponding engine operating data sets via respective cellular connections 6, 6′ via a fleet server 7, for example, a cloud.

The direct exchange via wireless network connection 5 has the advantage that engine control units 1, 1′ may set their control comparatively easily. In the present case, first fleet vehicle 2, which at the moment is underway in a low altitude sea level landscape at a high air pressure, may thus adjust for operation of the internal combustion engine under high load in a higher altitude with lower air pressure, as second fleet vehicle 2′ has to cope with at the moment. Conversely, engine control unit 1′ of second fleet vehicle 2′ may already adjust for operation of the internal combustion engine in the lower-lying sea level landscape with higher air pressure.

A memory unit 8 is already present in fleet server 7, which memory unit is configured for storing different, transmitted engine operating data sets of one or more engine control units 1, 1′. In addition, fleet server 7 is also equipped with a selection unit 9, which is configured to select at least one engine operating data set from the engine operating data sets stored in the memory unit, on the basis of which corresponding control unit 1, 1′ then sets the control variable. Thus, the stored engine operating data sets present have at least one environmental parameter, in order to assign the engine operating data sets to a respective environment, presently environment 10 or 10′ of vehicles 2, 2′, namely high pressure environment 10 and low pressure environment 10′. Thus, upon a respective request by corresponding fleet vehicles 2, 2′, fleet server 7 may select a suitable engine operating data set for respective environment 10, 10′ of fleet vehicle 2, 2′, and transmit it to engine control unit 1, 1′ of respective vehicle 2, 2′. In order to respectively select a suitable engine operating data set from the stored engine operating data sets, the environmental parameter respectively associated with the stored engine operating data sets may be compared to an environmental parameter detected by respective engine control unit 1, 1′ and transmitted, for example, to fleet server 7. Thus, in the example shown, an engine operating data set may be selected for first fleet vehicle 2, which is initially optimized for operation in high pressure environment 10. Later, when first fleet vehicle 2 is underway in low pressure environment 10′, a corresponding engine operating data set, for example, the engine operating data set previously transmitted from second fleet vehicle 2′ to fleet server 7, may then be transmitted.

Provision may also be made here that the stored engine operating data sets are optimized in fleet server 7 with further algorithms, or that optimized engine operating data sets, meta engine operating data sets, are generated from the stored engine operating data sets. For this purpose, a corresponding generation unit 9 may be provided. As the fleet may comprise a plurality of fleet vehicles 2, 2′, which in turn are located in a plurality of different environments 10, 10′ and may generate a large number of engine operating data sets, a method of machine learning may also be used for generating optimized meta engine operating data sets. The assigned generation unit 8 may thereby be located both in fleet server 7 or also in respective engine control unit 1, 1′.

1.-14. (canceled)

15. An engine control unit for an internal combustion engine of a fleet vehicle in a vehicle fleet with at least two fleet vehicles, the engine control unit comprising:
a control unit, which is configured to set control variables on the basis of measured variables according to a control scheme stored in the engine control unit;
characterized by
a data interface unit, which is configured to transmit respective engine operating data sets to/from another engine control unit of a respective internal combustion engine of at least one other fleet vehicle;
and characterized in that
the control unit is configured to set the control variables taking into consideration at least one engine operating data set of the other engine control unit(s) received via the data interface unit.

16. The engine control unit according to claim 15,
characterized in that
the engine operating data sets respectively comprise:
at least one measured variable comprising an engine rpm and/or a throttle valve position and/or a fuel injection amount and/or a residual combustion gas amount and/or an ignition timing and/or a valve opening time and valve closing time and/or an engine temperature and/or an intake-side gas mixture pressure and/or a pressure in the combustion chamber and/or an exhaust-side gas mixture pressure and/or an engine torque and/or an engine mileage/performance, and/or
at least one control variable comprising a throttle valve position and/or a fuel injection amount and/or an ignition timing and/or a valve opening time and valve closing time, and/or
at least one control scheme comprising an operating parameter map, and/or
at least one environmental parameter characterizing an environment of the engine control unit comprising a geographic position and/or an engine ambient air pressure and/or an engine ambient humidity and/or an engine ambient temperature and/or a fuel quality and/or an internal combustion engine type designation and/or a fleet vehicle type designation and/or a fleet vehicle mass.

17. The engine control unit according to claim 15,
characterized by
a memory unit which is configured for storing different, transmitted engine operating data sets of one or more engine control units, and
a selection unit, which is configured to select at least one engine operating data set from the engine operating data sets stored in the memory unit, on the basis of which the control unit sets the control variables, or to decide that the control variables are set on the basis of measured variables according to the control scheme stored in the engine control unit.

18. The engine control unit according to claim 17,
characterized in that
the stored engine operating data sets each comprise at least one environmental parameter and other engine operating data, and
the selection unit is configured to compare the at least one environmental parameter of the stored engine operating data sets with an environmental parameter correspondingly detected by the engine control unit, and to select the engine operating data set from the stored engine operating data sets according to a comparison result, on the basis of which the control unit sets the control variables.

19. The engine control unit according to claim 18,
characterized in that the other engine operating data comprises a control scheme.

20. The engine control unit according to claim 18,
characterized in that
the selection unit is configured to select an engine operating data set, for which the comparison result yielded the lowest deviation from the environmental parameter detected by the engine control unit, for setting the control variables by the control unit.

21. The engine control unit according to claim 18,
characterized by
a generation unit configured as part of the selection unit, and which is configured to generate at least one meta engine operating data set from the engine operating data sets stored in the memory unit, wherein, in particular, the engine operating data sets underlying a respective meta engine operating data set each comprise at least one environmental parameter, which each differ from one another by less than a predetermined limit value.

22. The engine control unit or engine control system according to claim 21,
characterized in that
the generation unit generates the at least one meta engine operating data set from the stored engine operating data sets by means of machine learning, wherein the machine learning in particular optimizes a torque response and/or fuel consumption and/or an exhaust gas composition.

23. The engine control unit according to claim 15, wherein the data interface unit is configured to transmit the engine operating data sets via a fleet server.

24. The engine control unit according to claim 15,
characterized in that
the data interface unit comprises a wireless fleet-vehicle-to-fleet-vehicle data interface unit, which includes a limited transmission range of less than 10 km.

25. The engine control unit according to claim 24,
characterized in that
the limited transmission range is less than 5 km.

26. The engine control unit according to claim 24,
characterized in that
the limited transmission range is less than 2 km.

27. The engine control unit according to claim 24,
characterized in that
the limited transmission range is less than 1 km.

28. The engine control unit according to claim 15,
characterized in that
the data interface unit comprises a wireless fleet-vehicle-to-fleet-server data interface unit which is configured to transmit the engine operating data sets via a fleet server.

29. A method for operating an engine control unit of an internal combustion engine of a fleet vehicle in a vehicle fleet with at least two fleet vehicles, the method comprising:
transmitting engine operating data sets from the engine control unit to at least one other engine control unit of an internal combustion engine of one other fleet vehicle.

30. The method of claim 29, wherein transmitting the engine operating data sets from the engine control unit to the at least one other engine control unit includes transmission over a wireless local area network.

31. The method of claim 29, wherein transmitting the engine operating data sets from the engine control unit to the at least one other engine control unit includes transmission over a cellular connection.

32. The method of claim 29, wherein transmitting the engine operating data sets from the engine control unit to the at least one other engine control unit includes transmission via a fleet server.

33. A method for operating an engine control unit of an internal combustion engine of a fleet vehicle in a vehicle fleet with at least two fleet vehicles, the method comprising:
receiving at least one engine operating data set from at least one other engine control unit of an internal combustion engine of one other fleet vehicle at the engine control unit;
setting control variables of the engine control unit while considering at least one of the received engine operating data set(s) of the at least one other engine control unit.

34. The method of claim 33, wherein receiving at least one engine operating data set includes transmitting the at least one engine operating data set via a wireless local area network, a cellular connection, or a fleet server.
